(19) United States
(12) Patent Application Publication
(10) Pub. No.: US 2020/0216200 A1
(43) Pub. Date: Jul. 9, 2020

(54) Grapple-Fixture Deployment Device

(71) Applicant: Nanoracks, Webster, TX (US)

(72) Inventors: Michael Desmond Lewis, Webster, TX (US); J. Brockton Howe, Webster, TX (US); Mark David Rowley, Webster, TX (US); Steven Stenzel, Webster, TX (US)

(21) Appl. No.: 16/734,176

(22) Filed: Jan. 3, 2020

Related U.S. Application Data
(60) Provisional application No. 62/788,071, filed on Jan. 3, 2019.

(51) Int. Cl. B64G 1/64; B64G 4/00

(52) U.S. Cl. CPC B64G 1/641; B64G 1/222; B64G 4/00

(57) ABSTRACT

A grapple-fixture deployment device allows for an easy, quick, and safe disposal of an unnecessary payload from a space station. The grapple-fixture deployment device includes a space station remote manipulator system (SSRMS)-securing module, a separation system, a payload-securing module, a first attachment mechanism, and a second attachment mechanism. The SSRMS-securing module allows the grapple-fixture deployment device to be attached to the robotic arm apparatus of a mobile servicing system (MSS). The separation system is a spacecraft deployment system that is used to eject the payload-securing mechanism from the rest of the grapple-fixture deployment device. The payload-securing module allows the grapple-fixture deployment device to be attached to a payload. The first attachment mechanism is used to attach the SSRMS-securing module to the robotic arm apparatus of a MSS. The second attachment mechanism is used to attach the payload-securing module to the payload.

The current application claims a priority to the U.S. Provisional Patent application Ser. No. 62/788,071 filed on Jan. 3, 2019.

### FIELD OF THE INVENTION

The present invention relates generally to devices for the deployment of unnecessary equipment from the International Space Station or other orbital platforms. The present invention ideally constitutes an apparatus operated in conjunction with existing manipulator arms enabling the disposal of attached payloads.

### BACKGROUND OF THE INVENTION

In present times, both private and public space agencies are known to employ robotic systems onboard orbital platforms and vehicles to enable a remote operator to perform extravehicular activities (EVA) from the safety of a pressurized capsule. The international Space Station (ISS) features a series of dedicated grapple fixtures and robotic arms on various modules congruent to this purpose. The Flight-Releasable Grapple Fixture (FRGF) and the Latchable Grapple Fixture (LGF) may, in various applications, provide mechanical purchase to Latching End Effectors (LEE) such as those found on the terminal ends of the Mobile Servicing System (MSS) or the Japanese Experiment Module Remote Manipulator System (JEMRMS). The grapple fixtures, in addition to providing a point to which the robotic arms may attach, may additionally allow for hardline data and electrical supply connections to be carried across congruent features of the LEE and the grapple. Examples of such fixtures include the Power and Video Grapple Fixture (PVGF) and the Power and Data Grapple Fixture (PDGF), fixtures capable of facilitating transmission of data, live video, electrical power, and control commands. Further explanation of the form and function of known grapple fixtures and their codified functionalities in conjunction with robotic arms and LEE systems may be found in the National Air and Space Administration publication SSP42004 “Mobile Servicing System (MSS) to User (Generic) Interface Control Document”. It is understood that not all grapple fixtures may necessarily be compatible with all LEE-types, creating a hardware incompatibility that may be crippling to on-orbit missions where additional equipment is simply unavailable. It is therefore advantageous to possess a system that may bridge these incompatibilities and offer variable functionalities pursuant to a solution for any given problem that may be addressed with a robotic arm.

The present invention aims to provide an apparatus that may be serviced, reconfigured, reloaded, refurbished, and otherwise operated by on-station personnel and systems to enable a robotic arm to effectively integrate with any known grapple fixture. Further ideal embodiments of the present invention include a detachable “flyaway” segment that may provide non-pyrotechnic means of ejection of modules to be destroyed on re-entry to the atmosphere. The expended “remain” segment may then be returned to a pressurized environment for refurbishment and reload processes. In various alternative embodiments, the present invention will additionally comprise a series of interchangeable LEE-like components that may enable any grappler arm to perform a variety of other functions understood to be performed by robotic arms or personnel on EVA maneuvers.

### BRIEF DESCRIPTION OF THE DRAWINGS

FIG. 1 is a top perspective view of the present invention.

FIG. 2 is a bottom perspective view of the present invention.

FIG. 3 is a side view of the present invention.

FIG. 4 is an exploded top perspective view of the present invention.

FIG. 5 is an exploded bottom perspective view of the present invention.

FIG. 6 is a perspective of the present invention in preparation to connect to a payload.

FIG. 7 is a side view of the present invention connected to the payload.

FIG. 8 is a perspective view of the present invention ejecting the payload-securing module along with the payload.

FIG. 9 is a side schematic view illustrating the electronic connections of the present invention.

### DETAIL DESCRIPTIONS OF THE INVENTION

All illustrations of the drawings are for the purpose of describing selected versions of the present invention and are not intended to limit the scope of the present invention.

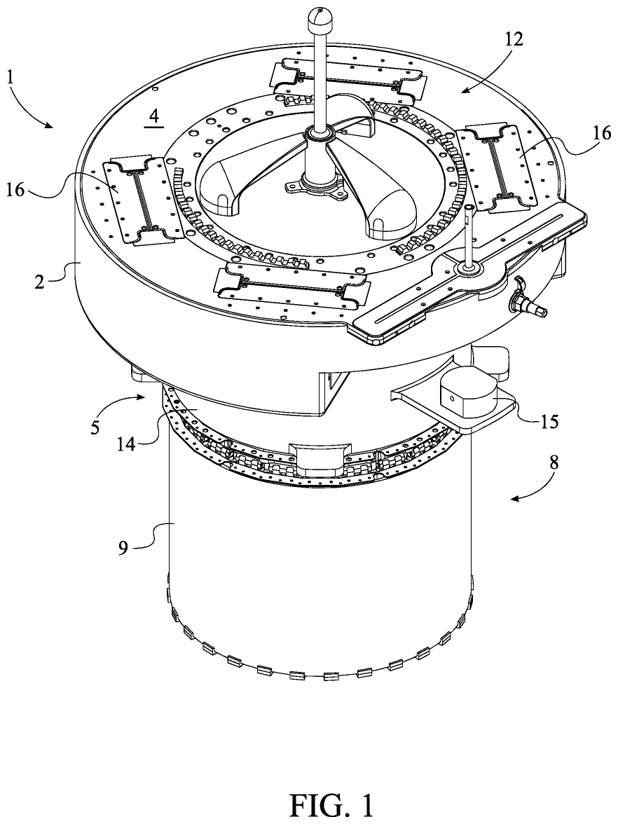

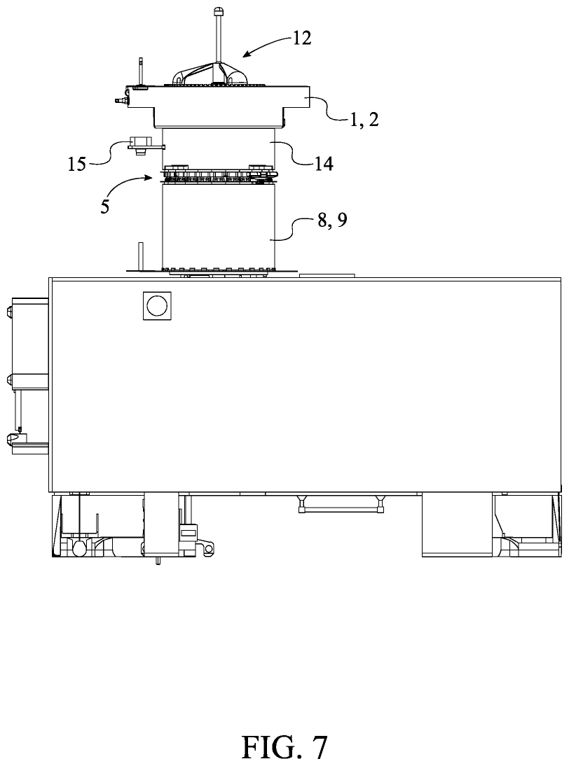

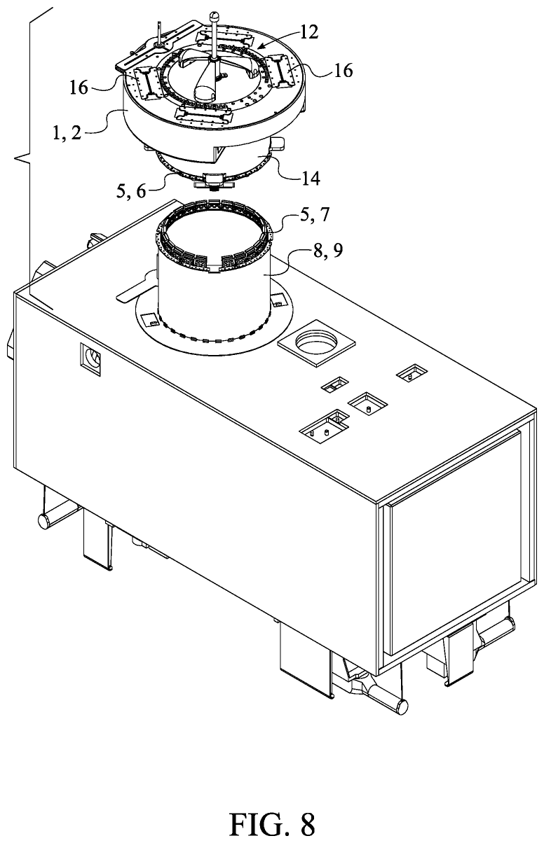

In reference to FIGS. 1 through 8, the present invention is a grapple-fixture deployment device which allows for an easy, quick, and safe disposal of an unnecessary payload from a space station. The present invention comprises a space station remote manipulator system (SSRMS)-securing module 1, a separation system 5, a payload-securing module 8, a first attachment mechanism 12, and a second attachment mechanism 13. The SSRMS-securing module 1 allows the present invention to be attached to the robotic arm apparatus of a mobile servicing system (MSS). The separation system 5 is a spacecraft deployment system that is used to eject the payload-securing mechanism from the rest of the present invention. The separation system 5 may be any type of spacecraft deployment system such as, but not limited to, a non-pyrotechnic or a pyrotechnic spacecraft separation system. The payload-securing module 8 allows the present invention to be attached to a payload. The first attachment mechanism 12 is used to attach the SSRMS-securing module 1 to the robotic arm apparatus of a MSS. The second attachment mechanism 13 is used to attach the payload-securing module 8 to the payload.

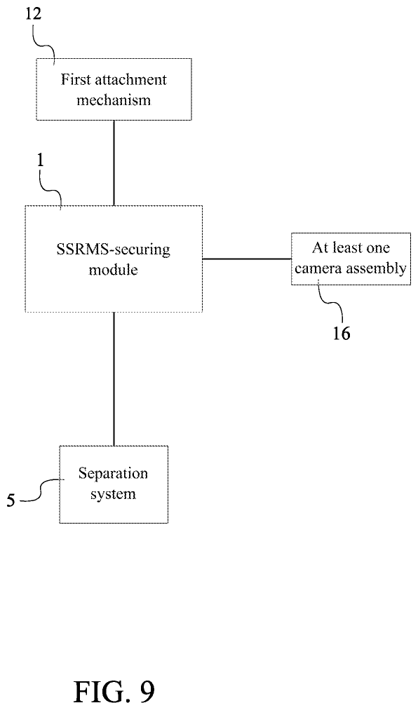

The general configuration of the aforementioned components allows for an easy, quick, and safe disposal of unnecessary payload from a space station. With reference to FIGS. 1 through 4, the SSRMS-securing module 1 comprises a first module body 2, a proximal module face 3, and a distal module face 4. The proximal module face 3 and the distal module face 4 are positioned opposite to each other across about the first module body 2. The payload-securing module 8 comprises a second module body 9, a proximal module end 10, and a distal module end 11. The proximal module end 10 and the distal module end 11 are positioned opposite to each other about the second module body 9. The first attachment mechanism 12 is mounted onto the distal module face 4. The first attachment mechanism 12 may be mounted to the distal module face 4 by a variety of methods including, but not limited to, using a set of fasteners. Thus, the first attachment mechanism 12 is fully secured to the SSRMS-securing module 1. The second attachment mechanism 13 is integrated into the second module body 9 from the distal module end 11. In further detail, the second module body 9 is modified in order to receive the grapple fixture of the payload. The proximal module face 3 is attached onto the proximal module end 10 by the separation system 5. This arrangement allows the payload-securing module 8 to be separated from the SSRMS-securing module 1 through actuation of the separation system 5. With reference to FIG. 9, the SSRMS-securing module 1 is electronically connected to the separation system 5 and the first attachment mechanism 12. This arrangement allows the SSRMS-securing module 1 to manage and control the separation system 5 and the first attachment mechanism 12. Moreover, this allows an SSRMS to manage and control the separation system 5 and the first attachment mechanism 12 through the SSRMS-securing module 1.

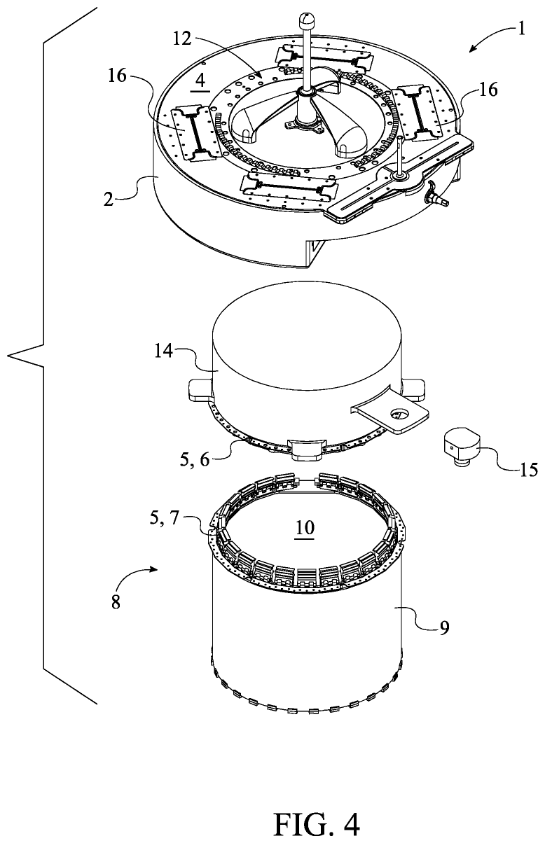

With reference to FIGS. 1 and 4, the SSRMS-securing module 1 cannot be directly connected to the separation system 5. Therefore, the present invention may further comprise an intermediate adapter 14 in order to connect the SSRMS-securing module 1 to the separation system 5. The intermediate adapter 14 is connected in between the separation system 5 and the proximal module face 3. The intermediate adapter 14 may be connected to the SSRMS-securing module 1 through a variety of methods including, but not limited to, using a set of fasteners or high-power magnets. Preferably, the intermediate adapter 14 is connected to the SSRMS-securing module 1 through a 6-bolt grapple fixture interface. Thus, the SSRMS-securing module 1 is connected to the separation system 5 through the intermediate adapter 14.

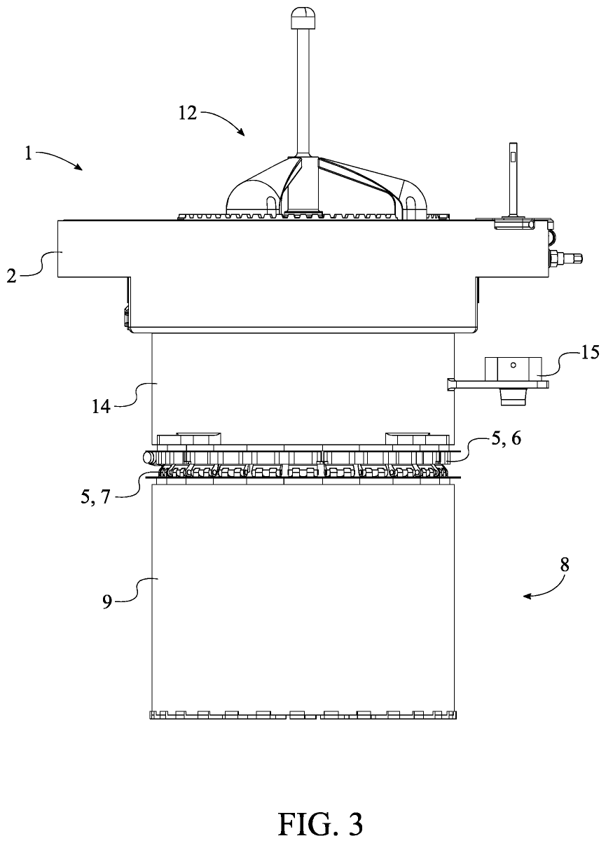

In order to properly attach the present invention to the payload and with reference to FIG. 3, the present invention may further comprise at least one camera assembly 15. The at least one camera assembly 15 may be any video-recording device that will allow an individual to view the process of attaching the payload-securing module 8 to the payload. The at least one camera assembly 15 is positioned in between the separation system 5 and the proximal module face 3 and is mounted adjacent to the intermediate adapter 14. This arrangement positions and secures the at least one camera assembly 15 to the intermediate adapter 14 in a manner where an individual can clearly view the process of attaching the payload-securing module 8 to the payload. Furthermore and with reference to FIG. 9, the SSRMS-securing module 1 is electronically connected to the at least one camera assembly 15. This allows an SSRMS to manage and control the at least one camera assembly 15 through the SSRMS-securing module 1.

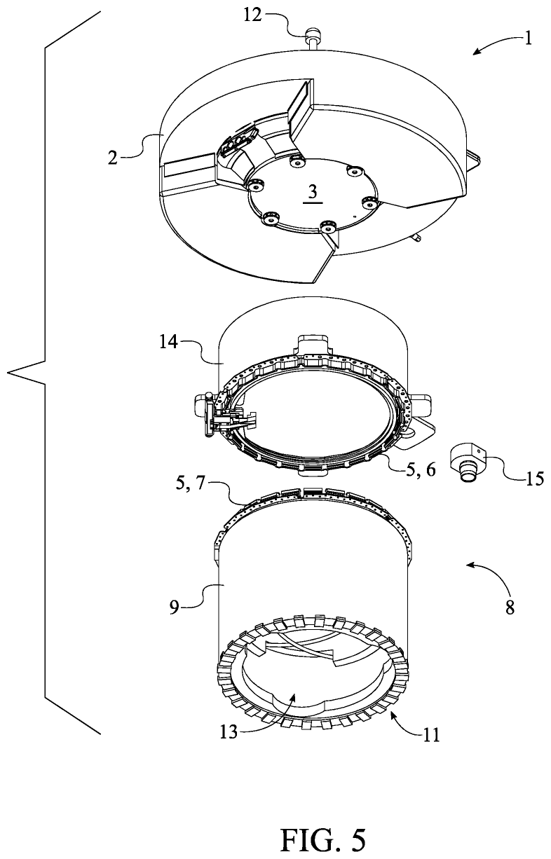

With reference to FIGS. 4 and 5, the separation system 5 comprises a first interlocking portion 6 and a second interlocking portion 7. The first interlocking portion 6 is a structural ring that includes a separation switch. The second interlocking portion 7 is a structural ring that includes a plurality of separation springs. The first interlocking portion 6 is connected adjacent to the intermediate adapter 14, opposite the proximal module face 3, and the second interlocking portion 7 is connected adjacent to the proximal module end 10. The first interlocking portion 6 may be connected to the intermediate adapter 14 through a variety of methods including, but not limited to, using a set of fasteners. Similarly, the second interlocking portion 7 may be connected to the payload-securing module 8 through a variety of methods including, but not limited to, using a set of fasteners. This arrangement allows the second interlocking portion 7 to eject itself from the first interlocking portion 6 through the separation springs when the separation switch is actuated. Preferably, the separation system 5 is a mechanically-actuated separation system and specifically is not a pyrotechnic separation system. Furthermore, the separation system 5 is preferably a Lightband separation system 5 provided by Planetary Systems Corporation. As previously mentioned, the Lightband separation system 5 uses a separation switch and a plurality of separation springs in order to deploy the payload.

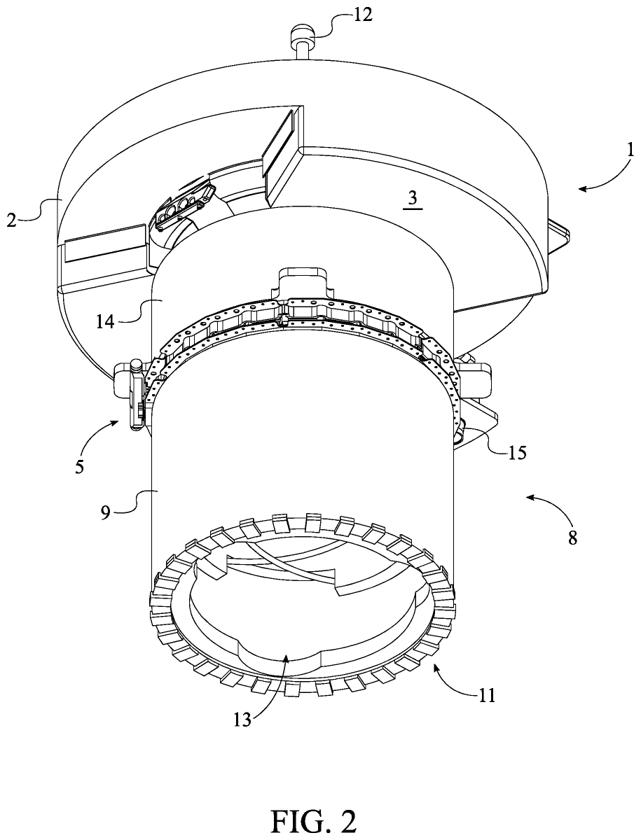

Preferably and with reference to FIGS. 1 and 2, the first attachment mechanism 12 is a power and video grapple fixture (PVGF). The PVGF is a specific type of grapple fixture which allows the transfer of data, video, and power between the SSRMS-securing module 1 and the SSRMS. Furthermore, the present invention may further comprise a plurality of SSRMS interfaces 16. The plurality of SSRMS interfaces 16 is a set of electrical connectors that enables the transfer of data, video, and power. The plurality of SSRMS interfaces 16 is integrated into the first attachment mechanism 12. Thus, an SSRMS can be communicably coupled to the SSRMS-securing module 1 through the first attachment mechanism 12. Preferably, the second attachment mechanism 13 is a flight releasable grapple fixture (FRGF). The FRGF is the simplest type of grapple fixture used only to attach a spacecraft module to a payload.

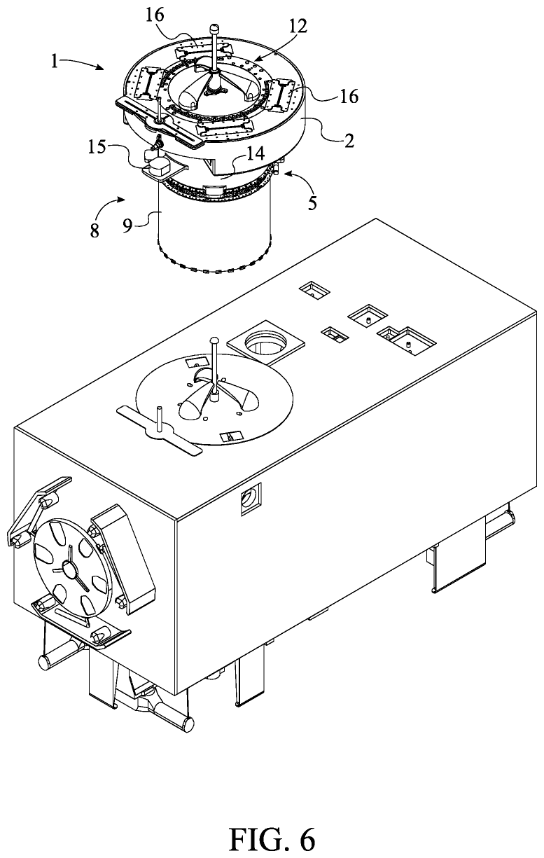

With reference to FIGS. 6 through 8, the present invention includes a method in order to properly dispose of an unnecessary payload from a space station. First, the robotic arm apparatus of an MSS is securely attached to the SSRMS-securing module 1 through the first attachment mechanism 12. Then, the SSRMS maneuvers the present invention in order to attach the payload-securing module 8 to the payload through the second attachment mechanism 13. The separation system 5 is then actuated to eject the payload-securing module 8 from the rest of the present invention, and therefore, dispose of the payload.

Although the invention has been explained in relation to its preferred embodiment, it is to be understood that many other possible modifications and variations can be made without departing from the spirit and scope of the invention as hereinafter claimed.

What is claimed is:

1. A grapple-fixture deployment device comprises:
a space station remote manipulator system (SSRMS)-securing module;
a separation system;
a payload-securing module;
a first attachment mechanism;
a second attachment mechanism;
the SSRMS-securing module comprises a first module body, a proximal module face, and a distal module face;
the proximal module face and the distal module face being positioned opposite to each other about the first module body;
the payload-securing module comprises a second module body, a proximal module end, and a distal module end;
the proximal module end and the distal module end being positioned opposite to each other about the second module body;
the first attachment mechanism being mounted onto the distal module face;
the second attachment mechanism being integrated into the second module body from the distal module end;
the proximal module face being attached onto the proximal module end by the separation system; and
the SSRMS-securing module being electronically connected to the separation system and the first attachment mechanism.

2. The modular grapple apparatus as claimed in claim 1 comprises:
an intermediate adapter; and
the intermediate adapter being connected in between the separation system and the proximal module face.

3. The grapple-fixture deployment device as claimed in claim 2 comprises:
at least one camera assembly;
the at least one camera assembly being positioned in between the separation system and the proximal module face;
the at least one camera assembly being mounted adjacent to the intermediate adapter; and
the SSRMS-securing module being electronically connected to the at least one camera assembly.

4. The grapple-fixture deployment device as claimed in claim 2 comprises:
the separation system comprises a first interlocking portion and a second interlocking portion;
the first interlocking portion being connected adjacent to the intermediate adapter, opposite the proximal module face; and
the second interlocking portion being connected adjacent to the proximal module end.

5. The grapple-fixture deployment device as claimed in claim 1 comprises:
the separation system being a mechanically-actuated separation system.

6. The grapple-fixture deployment device as claimed in claim 5 comprises:
the separation system being a Lightband separation system.

7. The grapple-fixture deployment device as claimed in claim 1 comprises:
the first attachment mechanism being a power and video grapple fixture (PVGF).

8. The grapple-fixture deployment device as claimed in claim 1 comprises:
a plurality of SSRMS interfaces;
the plurality of SSRMS interfaces being integrated into the first attachment mechanism.

9. The grapple-fixture deployment device as claimed in claim 1 comprises:
the second attachment mechanism being a flight releasable grapple fixture (FRGF).

10. A grapple-fixture deployment device comprises:
a space station remote manipulator system (SSRMS)-securing module;
a separation system;
a payload-securing module;
a first attachment mechanism;
a second attachment mechanism;
an intermediate adapter;
a plurality of SSRMS interfaces;
the SSRMS-securing module comprises a first module body, a proximal module face, and a distal module face;
the proximal module face and the distal module face being positioned opposite to each other about the first module body;
the payload-securing module comprises a second module body, a proximal module end, and a distal module end;
the proximal module end and the distal module end being positioned opposite to each other about the second module body;
the first attachment mechanism being mounted onto the distal module face;
the second attachment mechanism being integrated into the second module body from the distal module end;
the proximal module face being attached onto the proximal module end by the separation system;
the SSRMS-securing module being electronically connected to the separation system and the first attachment mechanism;
the intermediate adapter being connected in between the separation system and the proximal module face; and
the plurality of SSRMS interfaces being integrated into the first attachment mechanism.

11. The grapple-fixture deployment device as claimed in claim 10 comprises:
at least one camera assembly;
the at least one camera assembly being positioned in between the separation system and the proximal module face;
the at least one camera assembly being mounted adjacent to the intermediate adapter; and
the SSRMS-securing module being electronically connected to the at least one camera assembly.

12. The grapple-fixture deployment device as claimed in claim 10 comprises:
the separation system comprises a first interlocking portion and a second interlocking portion;
the first interlocking portion being connected adjacent to the intermediate adapter, opposite the proximal module face; and
the second interlocking portion being connected adjacent to the proximal module end.

13. The grapple-fixture deployment device as claimed in claim 10 comprises:
the separation system being a mechanically-actuated separation system.

14. The grapple-fixture deployment device as claimed in claim 13 comprises:
the separation system being a Lightband separation system.

15. The grapple-fixture deployment device as claimed in claim 10 comprises:
the first attachment mechanism being a power and video grapple fixture (PVGF).

16. The grapple-fixture deployment device as claimed in claim 10 comprises:
the second attachment mechanism being a flight releasable grapple fixture (FRGF).
